(19) United States
(12) Patent Application Publication
(10) Pub. No.: US 2018/0056500 A1
(43) Pub. Date: Mar. 1, 2018

(54) TOOL HOLDER

(71) Applicant: Ralph Reeves, Rising Sun, MD (US)

(72) Inventor: Ralph Reeves, Rising Sun, MD (US)

(21) Appl. No.: 15/246,701

(22) Filed: Aug. 25, 2016

(51) Int. Cl. B25H 3/00; F16M 13/00; A61C 13/15

(52) U.S. Cl. CPC B25H 3/00; A61C 19/003; F16M 13/00

(57) ABSTRACT

A holder for supporting an elongated tool in an upright position on a planar surface. The holder comprises a body defined by a semicircular or semielliptical section of a longitudinal section of a hollow cylinder, the body having a thickness from an interior wall to an exterior wall, the holder configured to stand with the radius of the semicircular or semielliptical section perpendicular to the planar surface. A through-hole in the body is sized to accommodate a periphery of the tool. A tool and holder system may include the holder and an elongated tool having a generally cylindrical geometry, such as a curing tool configured to emit radiation having a predetermined wavelength for curing a dental resin.

### BACKGROUND OF THE INVENTION

One aspect of the invention is a holder for holding a cylindrical tool, such as a dental tool, on a flat surface.

### SUMMARY OF THE INVENTION

One aspect of the invention comprises a holder for supporting an elongated tool in an upright position on a planar surface. The holder comprises a body comprising a semicircular or semielliptical section of a longitudinal section of a hollow cylinder, the body having a thickness from an interior wall to an exterior wall, the holder configured to stand with the radius of the semicircular or semielliptical section perpendicular to the planar surface supported by two rectangular feet defined by a planar section of the thickness, each of the rectangular feet having a long edge defined by a width of the longitudinal section and a short edge defined by the thickness of the body. A through-hole in the body is sized to accommodate a periphery of the tool. Preferred embodiments may include configurations in which the semicircular or semielliptical section is less than a half section, the hollow cylinder has an elliptical cross-section, in which the through-hole is a circular through-hole, or a combination thereof.

Another aspect of the invention comprises a tool and holder system, wherein the holder as previously defined, and the tool is an elongated tool. The elongated tool may have a generally cylindrical geometry. In a preferred embodiment, the elongated tool may be a dental instrument, such as a curing tool configured to emit radiation having a predetermined wavelength for curing a dental resin.

Yet another aspect of the invention comprises a tool and holder system, comprising the elongated generally cylindrical tool having a generally circular periphery and comprising a dental instrument configured to emit radiation having a predetermined wavelength for curing a dental resin, and a holder configured to support the tool in an upright position on a planar surface. The holder comprises a body comprising a semicircular or semielliptical section of a longitudinal section of a hollow cylinder, the body having a thickness from an interior wall to an exterior wall. the semicircular or semielliptical section having a radius, wherein the semicircular section is less than a half section, the hollow cylinder has an elliptical cross-section, or a combination thereof. The holder is configured to stand in a position with the radius of the semicircular or semielliptical section perpendicular to the planar surface supported by two rectangular feet defined by a planar section of the thickness, each of the rectangular feet having a long edge defined by a width of the longitudinal section and a short edge defined by the thickness of the body. A circular through-hole in the body is sized to accommodate the periphery of the tool.

A further aspect of the invention is the design of a tool holder as depicted in the figures. It should be noted that variations of the claimed design may include embodiments including all of the features as depicted in the Figures, or in which any one of the features, such as but not limited to the shape or size of the through-hole, are only exemplary and not specifically claimed as a feature of the design.

### BRIEF DESCRIPTION OF THE DRAWINGS

FIG. 1 depicts a side view schematic drawing of an exemplary embodiment of the invention, showing an exemplary tool being held.

FIG. 2 depicts a top view of the exemplary embodiment of FIG. 1, without the exemplary tool.

FIG. 3 depicts a bottom view of the exemplary embodiment of FIG. 1, without the exemplary tool.

FIG. 4 depicts the right and left views of the exemplary embodiment of FIG. 1, without the exemplary tool.

FIG. 5 depicts a perspective view of the exemplary embodiment of FIG. 1, including the exemplary tool.

FIG. 6 depicts an exemplary hollow cylinder having an elliptical cross section, depicting an exemplary geometry of an embodiment of the holder.

FIG. 7 depicts an exemplary hollow cylinder having a circular cross section, depicting another exemplary geometry of an embodiment of the holder.

FIG. 8A depicts a top view of an exemplary insert.

FIG. 8B depicts a cross sectional view of the exemplary insert of FIG. 8A.

FIG. 8C depicts a top view of another exemplary insert.

### DETAILED DESCRIPTION OF THE INVENTION

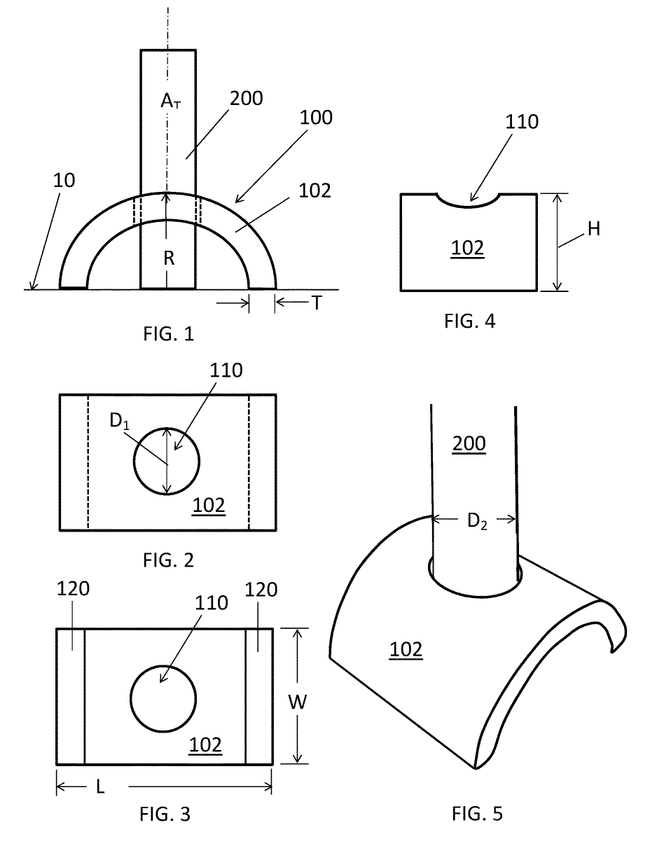

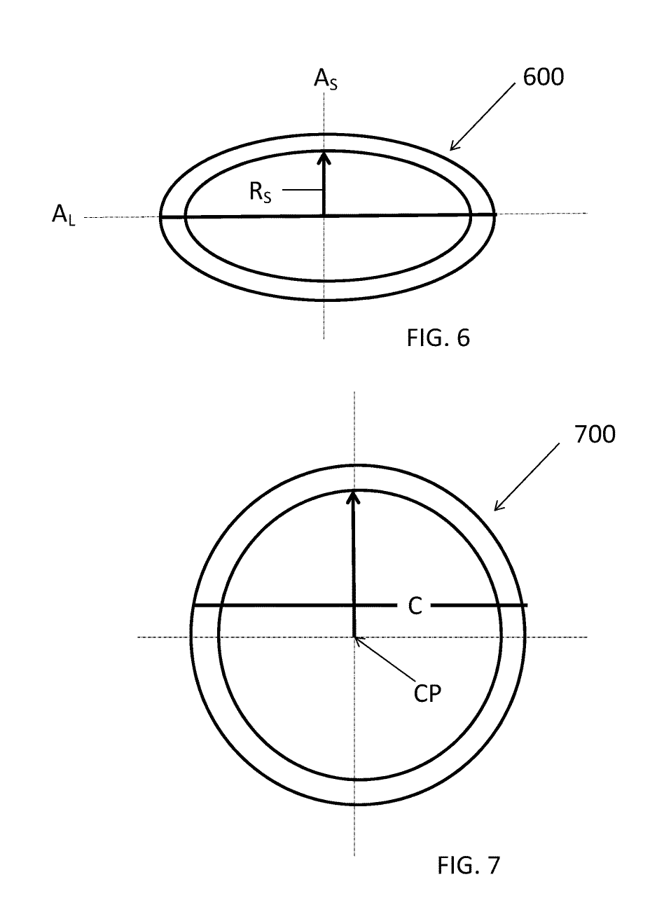

Referring now to the drawings, FIGS. 1-7 depict various views of an exemplary tool holder 100 of the present invention, some of which show an exemplary tool 200 that forms part of a claimed system of the tool and holder, and others of which omit depiction of the tool for simplicity of the drawings.

As shown in the side view of FIG. 1, the exemplary holder 100 comprises a body 102 defined by a semicircular or semielliptical section of a hollow cylinder, specifically a hollow cylinder having a radius R and a wall thickness T. The cylinder may have any geometric cross section and the semicircular or semielliptical section may be half, more than half, or less than half of that geometric cross section. The holder is configured to support elongated tool 200 in an upright position on a planar surface 10, with the holder standing on feet 102 with radius R of the semicircular or semielliptical section positioned perpendicular to the planar surface 10. Through-hole 110 in body 102 sized to accommodate a periphery of the tool. As shown in the figures, the elongated tool has a generally cylindrical shape with a generally circular cross section having a diameter D₂, and through-hole 110 is also circular in geometry, having a diameter D₁ that is sufficiently larger than D₂ to provide ease of insertion and removal from the through-hole as well as sufficient lateral support to keep the tool stabilized in the upright position (i.e. with the longitudinal axis A_{T} of the elongated tool generally perpendicular to planar surface 10).

In a preferred embodiment, the dental tool is a dental instrument configured to emit radiation having a predetermined wavelength for curing a dental resin, such as a VALO® cordless LED curing light for producing high-intensity light having a wavelength in the range of 395-480 nm, which is capable of polymerizing all light-cured dental materials, such as is manufactured by Ultradent Products, Inc. of South Jordan, Utah, in the United States.

In one exemplary embodiment, L=3.5 inches, W=3 inches, and H=1.5 inches. The invention is not limited to any particular geometry, however. A geometric configuration in which 2H<L may be defined by hollow cylinder 600 that forms the holder body having an elliptical cross section, such as is depicted in FIG. 6, in which the semi-elliptical section is a half section taken along a longitudinal plane perpendicular to the cross section and defined by the longer axis A_{L} of the ellipse, such that radius R is the radius of the ellipse taken along the shorter axis A_{S} of the ellipse. In an alternate embodiment, depicted in FIG. 7, the hollow cylinder 700 may have a circular cross section, and the chord C that forms the section of the circle may be taken along a longitudinal plane that is offset from the longitudinal axis runs through center point CP of the circle, such the length of chord C is less than the diameter of the circular cross section, and the height H of the body is therefore less than the radius R of the circle. It should be understood that the semicircular or semielliptical section may also be less than half of a cross sectional portion of a cylinder having an elliptical cross section. Furthermore, the section may be more than, less than, or exactly half of the cross sectional portion, and the longitudinal section lie along or be offset from the long axis or the short axis of an elliptical cross section.

It should be understood that FIGS. 6 and 7 are for illustration only to describe a general geometry of an exemplary holder geometry. While one manufacturing technique may be to produce a hollow cylinder having the depicted cross section, sectioning that cylinder to create a portion having a width W, and then longitudinally sectioning the portion as depicted in FIGS. 6 and 7 to create the holder with a desired geometric shape, the geometric shape may be molded to the preferred geometry without any need to actually produce cylinders and cut them, or may be extruded in a semicircular or semi-elliptical geometry and then cut into portions having the desired width.

Although shown with a circular hole to match the generally circular cross section of the exemplary tool depicted in FIG. 1, the through-hole and the tool each may have any peripheral geometry. While the peripheries of the tool and the through-hole are preferably a geometric match, the invention is not limited to any particular relationship between the through-hole and the tool periphery.

The holder may comprise metal, such as stainless steel, or plastic, but is not limited to any particular construction. In general, a tool holder for use in a medical environment, such as for holding a dental tool, may optionally be made of a material that can withstand one or more typical sterilization techniques known for use in the medical field, such as, for example, autoclaving, dry heat, irradiation, chemical treatment, gamma ray treatment, or e-beam treatment. Suitable and preferred materials that meet such criteria are well known in the art, including various medical grade plastics, with new or variations on such materials continually being developed. For example, in one non-limiting example, the holder may comprise polycarbonate. An advantage of using a plastic rather than metal materials includes lower cost, the ability to provide the holder in one or more colors, and, perhaps most importantly, because the relatively lesser hardness of a plastic holder will be less likely to scratch the relatively harder finish on a metal tool.

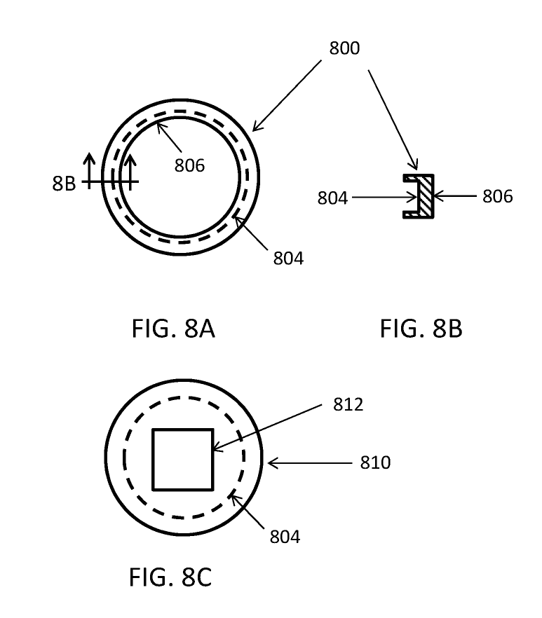

Similarly, an anti-scratch coating or removable insert having such a lesser hardness than the tool periphery, such as a removable flexible plastic material insert or coating, may be provided as a lining that defines the inside periphery of the through-hole that may make contact with the outside periphery of the tool in the held position or when inserting or removing the tool into or from the holder. Exemplary liner inserts 800, 810, shown in FIGS. 8A-8C may be provided with an internal periphery 804 that mates with, and preferably is geometrically similar to and makes contact with, the inside periphery of the through-hole of the holder. The port in the liner may also have a periphery that is geometrically similar 806 to the through-hole in the holder, or geometrically different 812 from the through-hole in the holder, and is preferably geometrically similar to the outside periphery of the portions of the tool that may make contact with the liner in the held position or when inserting or removing the tool into or from the holder. As used herein, “geometrically similar,” means something has a generally similar geometry (e.g. a square, a circle), but may be different in size, such as the configuration shown in FIGS. 8A and 8B for an insert 800 configured to fit in the circular through-hole of the holder shown in FIGS. 1-5. In alternate embodiments, however, as shown in FIG. 8C, the through-hole in the holder may be circular, but the liner 810 may have a square through-hole 812 that better conforms to the tool outside periphery. The liner, liner port, and through-hole geometries are not limited to any particular geometries. Use of the holder with a through-hole liner permits a single, common holder design to be used to accommodate a plurality of tool peripheries. The materials of the liner, in addition to being of preferably lesser hardness than the tool outer periphery (which may itself have a non-metal, scratch-resistant coating or may be uncoated metal, such as stainless steel), may also be chosen to have a desirable coefficient of friction selected to provide a desired degree of friction for ease of removal from and replacement in the holder.

The invention is not limited to any particular materials of construction. Furthermore, systems comprising an insert are not limited for use in connection with a holder having any particular materials of construction, as the insert may not necessarily comprise materials having a lesser hardness than the materials of the holder. Functionality of an insert may include improved scratch resistance relative to the materials of the holder, flexibility for accommodating various types of tools having different outer peripheries used with a single holder, or a combination thereof. Thus, the inserts of FIGS. 8A-8C may be used for a plastic holder or a metal holder.

It should also be understood that the overall dimensions of the holder relative to the tool should permit the tool to be held upright in a stable position without a risk of tipping over. Accordingly, the clearance between the hole and the tool, the weight of the holder relative to the weight of the tool, and the height of the holder relative to the height of the tool may all be optimized to provide a desired level of stability. Thus, for the same tool, a suitable design for a holder made of metal may be different than a holder made of a less dense material. Additionally, the geometry of the bottom of the tool that will contact the planar surface when held may also be taken into account in the overall design. A tool with a substantially flat bottom that is capable of standing upright on its own may permit use of a tool holder geometry that is smaller in one or more dimensions (weight, wall thickness, length, width, height, or some combination thereof) than for an otherwise identical toll having a less substantially flat bottom. As used herein, the terms “substantially flat,” “substantially circular,” “substantially elliptical” and “substantially cylindrical” reflect that it is not necessary for any of the aspects so described herein to be perfectly flat, circular, elliptical, or cylindrical to remain within the intended scope of the invention.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A holder for supporting an elongated tool in an upright position on a planar surface, the holder comprising:
a body comprising a semicircular or semielliptical section of a longitudinal section of a hollow cylinder, the body having a thickness from an interior wall to an exterior wall, the semicircular or semielliptical section having a radius, the holder configured to stand with the radius of the semicircular or semielliptical section perpendicular to the planar surface and supported by two rectangular feet, each of the feet defined by a planar section of the thickness and having a long edge defined by a width of the longitudinal section and a short edge defined by the thickness of the body,
a through-hole in the body sized to accommodate a periphery of the tool.

2. The holder of claim 1, wherein the semicircular section is less than a half section, the hollow cylinder has an elliptical cross-section, or a combination thereof.

3. The holder of claim 1, wherein the through-hole is a circular through-hole.

4. A tool and holder system, comprising:
an elongated tool;
a holder configured to support the elongated tool in an upright position on a planar surface, the holder comprising:
a body comprising a semicircular or semielliptical section of a longitudinal section of a hollow cylinder, the body having a thickness from an interior wall to an exterior wall, the semicircular or semielliptical section having a radius, the holder configured to stand with the radius of the semicircular or semielliptical section perpendicular to the planar surface and supported by two rectangular feet, each of the feet defined by a planar section of the thickness and having a long edge defined by a width of the longitudinal section and a short edge defined by the thickness of the body,
a through-hole in the body sized to accommodate a periphery of the tool.

5. The tool and holder system of claim 4, wherein the holder body is less than a half section, the hollow cylinder has an elliptical cross-section, or a combination thereof.

6. The tool and holder system of claim 4, wherein the through-hole is a circular through-hole.

7. The tool and holder system of claim 4, wherein the elongated tool has a generally cylindrical geometry.

8. The tool and holder system of claim 4, wherein the elongated tool is a dental instrument.

9. The tool and holder system of claim 8, wherein the dental instrument is a curing tool configured to emit radiation having a predetermined wavelength for curing a dental resin.

10. A tool and holder system, comprising:
an elongated tool comprising a dental instrument configured to emit radiation having a predetermined wavelength for curing a dental resin;
a holder configured to support the tool in an upright position on a planar surface, the holder comprising:
a body comprising a semicircular or semielliptical section of a longitudinal section of a hollow cylinder, the body having a thickness from an interior wall to an exterior wall, the semicircular or semielliptical section having a radius, the holder configured to stand in a position with a radius of the semicircular or semielliptical section perpendicular to the planar surface, supported by two rectangular feet, each of the feet defined by a planar section of the thickness and having a long edge defined by a width of the longitudinal section and a short edge defined by the thickness of the body, wherein the semicircular or semielliptical section is less than a half section, the hollow cylinder has an elliptical cross-section, or a combination thereof, and
a through-hole in the body having an inside periphery sized to accommodate an outside periphery of the tool.

11. The tool and holder system of claim 10, wherein the through-hole is circular and the tool has a generally circular periphery in a portion configured to lie adjacent the through-hole of the holder when the tool is positioned with a bottom end of the tool resting on the planar surface.

12. The tool and holder system of claim 11, wherein the bottom end of the tool is substantially flat.

13. The tool and holder system of claim 11, wherein the periphery of the tool comprises a relatively harder material of construction than a material configured to contact the periphery of the tool in the through-hole.

14. The tool and holder system of claim 13, wherein the material configured to contact the periphery of the tool in the through-hole comprises a material of construction of the holder in its entirety.

15. The tool and holder system of claim 13, wherein the material configured to contact the periphery of the tool in the through-hole comprises a coating or insert positioned in the through-hole.

16. The tool and holder system of claim 15, wherein the material configured to contact the periphery of the tool in the through-hole is an insert having a an outer periphery configured to mate with an inner periphery of the through-hole and a port in the liner configured to accommodate the outer periphery of the tool.

17. The tool and holder system of claim 16, wherein the outer periphery of the liner and the port are geometrically similar.

18. The tool and holder system of claim 16, wherein the outer periphery of the liner and the port are geometrically different.

19. The tool and holder system of claim 16, wherein the holder comprises a material of construction having a greater hardness than the material of the insert.
